(19) United States
(12) Patent Application Publication
(10) Pub. No.: US 2008/0186369 A1
(43) Pub. Date: Aug. 7, 2008

(54) Remanufactured ink cartridges and methods of making the same

(76) Inventor: Benjamin A. Lyles, La Salle, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/701,688

(22) Filed: Feb. 2, 2007

(51) Int. Cl. B41J 2/175

(52) U.S. Cl. 347/87

(57) ABSTRACT

The present invention relates to a process for remanufacturing an ink jet ink cartridge. Specifically, the process relates to remanufacturing ink jet ink cartridges having design features that are designed to prevent the refill or otherwise reuse of the ink cartridge. The design features may include, but be not limited to, a memory device for tracking information relating to the cartridge such that ink may be prevented from flowing from the cartridge when a measured value reaches a threshold value. The present invention relates to a process whereby the memory device is manipulated to allow ink to freely flow from the cartridge.

### TECHNICAL FIELD

The present invention relates to processes for the remanufacturing of ink jet ink cartridges. Specifically, the present invention relates to the remanufacture of ink jet ink cartridges, each containing a memory device for recording “ink-out” data for preventing cartridges from being reused.

### BACKGROUND

It is generally known to utilize ink jet ink cartridges in so-called “ink jet” printers for printing of text and/or images. Typical ink jet printers have black ink, as well as a plurality of colors, the combinations of which can form the text and/or images. The ink is typically contained within a reservoir, typically called a “cartridge” that holds ink and, in combination with a print head, distributes the ink to a medium, such as, typically, paper, although other media, such as plastic, fabric, and other like media may be utilized with an ink jet printer. Ink jet printers generally are of two types: thermal or piezoelectric.

Most consumer inkjet printers, such as Canon, HP and Lexmark, use a thermal inkjet. Inside each partition of each ink cartridge is a heating element with a small metal plate or resistor. In response to a signal given by the printer, a tiny current flows through the metal or resistor causing it to warm up, whereby the ink immediately surrounding the heated plate is vaporized into a tiny air bubble inside a nozzle. An ink droplet is thereby forced out of the cartridge nozzle onto the printable media. This process typically takes place in a matter of milliseconds for each ink droplet.

The printing depends on the smooth flow of ink, which can be hindered if the ink begins to dry at the print head, such as can happen when an ink level becomes low. The ink also acts as a coolant to protect the metal-plate heating elements: when the ink supply is depleted, and printing is attempted, the heating element in thermal cartridges often bum out, permanently damaging the print head.

All Epson printers and most industrial inkjet printers use a piezoelectric crystal in each nozzle instead of a heating element. When current is applied, the crystal vibrates and changes shape or size, forcing a droplet of ink from the nozzle. A piezoelectric inkjet allows a wider variety of inks than thermal inkjets but is generally more expensive.

Typically, ink jet printers utilize a plurality of ink jet ink cartridges for dispensing ink to printable media. Specifically, a black ink cartridge may be utilized in combination with a plurality of colors, such as, typically, cyan, magenta and yellow ink to create text and/or images on the printable media. While an ink jet printer typically can be utilized for many printings, an ink cartridge typically has life associate therewith, such that when the ink runs down to a threshold level, or runs dry from the cartridge, the cartridge is typically removed and discarded, and a new cartridge that is full of ink is utilized. In this way, the ink jet printer can be utilized for many printings, while the cartridges are typically replaced at regular intervals.

Ink and the cartridges utilized in the ink jet printers are typically fairly costly, such that replacing ink cartridges can be expensive for a consumer. An economical approach is for the reuse of the empty ink cartridges so that customers are not required to purchase completely new cartridges for use in the printers.

Manufacturers of ink jet ink cartridges typically would rather consumers to purchase new cartridges for use in the printers, rather than purchase ink, possibly from a third party ink supplier, and refill or otherwise reuse spent ink cartridges. Therefore, many manufacturers of ink jet ink cartridges embed features designed to prevent the refilling or reuse of the cartridges.

For example, many ink jet ink cartridges are filled with ink through a fill hole located in particular locations, thereby making the utilization of these fill holes difficult. In addition, many ink cartridges require filling at negative pressure (under vacuum) to properly fill the cartridge or to properly feed the ink from the cartridge during use, thereby making refilling the cartridge very difficult, especially for the average consumer that does not have access to vacuum technology. Moreover, many ink jet cartridges must be sealed while the ink added thereto remains at negative pressure such that the negative pressure remains within the cartridge, thereby allowing the ink to feed properly when used.

In addition, some ink jet ink cartridges utilize a memory device that is attached to the cartridge that records “ink out” data, which artificially forces an ink cartridge to be unusable once a threshold volume of ink passes out of the ink cartridge. Therefore, should an ink jet ink cartridge be refilled with ink, the memory device prevents the refilled ink from feeding from the cartridge. Currently, ink jet ink remanufacture processes replace the memory device with an emulator, such as a replacement memory device, allowing the ink to freely flow from the cartridge when utilized in a printing process. However, it is time consuming and expensive to replace each cartridge with an emulator in this manner.

Therefore, a need exists for a process for remanufacturing an ink jet ink cartridge having a memory device, wherein the memory device is designed to prevent refilling or reusing the cartridge. Specifically, a need exists for a process for refilling an ink jet ink cartridge, and manipulating the memory device to allow ink to flow freely therefrom during a printing process.

### SUMMARY

The present invention relates to a process for remanufacturing an ink jet ink cartridge. Specifically, the process relates to remanufacturing ink jet ink cartridges having design features that are designed to prevent the refill or otherwise reuse of the ink cartridge.

To this end, in an embodiment of the present invention, a process for filling an ink jet ink cartridge is provided. The process generally comprises the steps of providing an ink jet ink cartridge comprising a memory device designed to prevent the reuse of the cartridge; opening an access portal in the cartridge to access an interior chamber of the cartridge; providing a negative pressure to the interior chamber of the cartridge; introducing ink into the cartridge; and manipulating the memory device to allow ink to flow from the cartridge in a printing process.

In a further embodiment of the present invention, an ink jet ink cartridge is provided. The ink jet ink cartridge is made by a process comprising the steps of providing an ink jet ink cartridge comprising a memory device designed to prevent the reuse of the cartridge; opening an access portal in the cartridge to access an interior chamber of the cartridge; providing a negative pressure to the interior chamber of the cartridge; introducing ink into the cartridge; and manipulating the memory device to allow ink to flow from the cartridge in a printing process.

In a still further embodiment of the present invention, a process for filling an ink jet ink cartridge with ink is provided. The process comprises the steps of providing an ink jet ink cartridge comprising a first memory device designed to prevent the reuse of the cartridge; opening an access portal in the cartridge to access an interior chamber of the cartridge; providing a negative pressure to the interior chamber of the cartridge; introducing ink into the cartridge; and replacing the first memory device with a second memory device.

### BRIEF DESCRIPTION OF THE DRAWINGS

FIG. 1 illustrates a system of the present invention illustrating an ink jet ink cartridge in combination with a print head and controlled by a control system, in an embodiment of the present invention.

FIG. 2 illustrates a flow chart of a process for filling an ink jet ink cartridge in an alternate embodiment of the present invention.

FIG. 3 illustrates a perspective view of an ink jet ink cartridge in a still further embodiment of the present invention.

### DETAILED DESCRIPTION

While this invention is susceptible to embodiments in many different forms, there is shown in the drawings and will herein be described an example of the invention with the understanding that the present disclosure is to be considered as an exemplification of the principles of the invention and is not intended to limit the broad aspect of the invention to the examples illustrated.

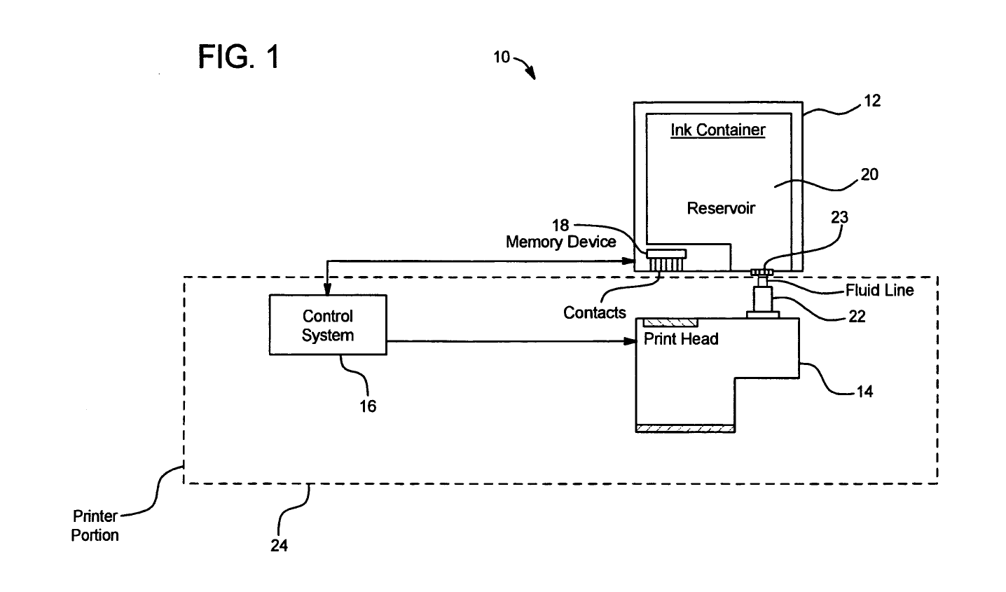

FIG. 1 is an example of a portion of an ink jet printing assembly 10. The ink jet printing assembly 10 includes an ink cartridge 12 and a printer portion 24 configured to receive the ink container 12. When the ink cartridge 12 is properly installed into the printer potion 24, ink is provided from the ink container 12 to the printer portion 24 such that ink can be deposited onto a printable medium. The cartridge 12 can be of a thermal-type or piezoelectric crystal-type.

The ink cartridge 12 is any container for holding ink jet ink utilized in an ink jet ink printer. The ink cartridge 12 typically has an internal compartment or reservoir 20 for holding the ink therein.

The printer portion 24 typically comprises a print head portion 14 containing a print head, and an ink supply needle 22 for withdrawing ink from the reservoir 20 of the ink cartridge 12 through an ink outlet port 23 on the ink jet ink cartridge 12. In an ink jet printing process, a control system 16 feeds electrical signals to the print head for depositing ink from the cartridge 12 onto the printable medium. In a typical thermal printing process, the print head comprises a small plate that is heated, thereby causing a bubble of ink to expand from the print head and be deposited onto the printable medium. In a piezoelectric printing process, an electrical signal is sent to a piezoelectric crystal, which vibrates and changes size or shape, and allows a droplet of ink to be deposited onto the printable medium. In either method, thermal printing or piezoelectric printing, text and/or an image may be printed onto the printable medium from the print head from black and/or one or more colors, such as, for example, cyan, magenta, yellow, or any other color useful for printing text and/or images onto printable media.

The ink cartridge 12 may further comprise a memory device 18 attached thereto in communication with the control system 16. The memory device 18 may contain data, such as, for example, a date of manufacture of the cartridge, a name for a manufacturer of the cartridge, and/or may measure and record data relating to an amount of ink that has flowed from the ink jet ink cartridge. Other data may include, but may not be limited to, a total amount of ink contained within the ink cartridge, a date of expiration, factory/production line information, the color of ink contained therein, a cartridge part number, a time of manufacture (hour and minute), and any other information apparent to one having ordinary skill in the art.

The data contained on the memory device may be utilized to prevent the reuse of the ink cartridge after the ink cartridge has been utilized one or more times. For example, the ink cartridge may be prevented from allowing ink to flow from the cartridge 12 if the present date is past a threshold date.

More typically, the memory device 18 may prevent ink from flowing from the ink cartridge after a threshold amount of ink flows from the cartridge. The memory device 18 may track the amount of ink flowing from the ink cartridge, and the control system 16 may prevent the ink from freely flowing therefrom after the amount of ink having flowed therefrom reaches the threshold amount. For example, the memory device 18 may initially contain data that indicates that the cartridge 12 is full. Typically, the “full” data on the memory device is when the data reads “100” or some other suitable amount indicating the cartridge 12 is full. Once spent, the data on the memory device may record that the amount of ink containing with in the cartridge 12 is zero, or some other number indicating the cartridge 12 is empty, or nearly empty. A consumer may then be inclined to remove the “spent” cartridge from the ink jet ink printer and replace the spent cartridge with a fresh cartridge.

In a filling process of the present invention, the ink cartridge 12 may be refilled with new or fresh ink after the ink jet ink cartridge has been used one or more times. For example, if an ink jet cartridge has been depleted, and the memory device 18 prevents the use of the cartridge by the control system 16, especially after having been refilled with ink, the process of the present invention manipulates the memory device, thereby allowing the cartridge to be reused after having been refilled with ink.

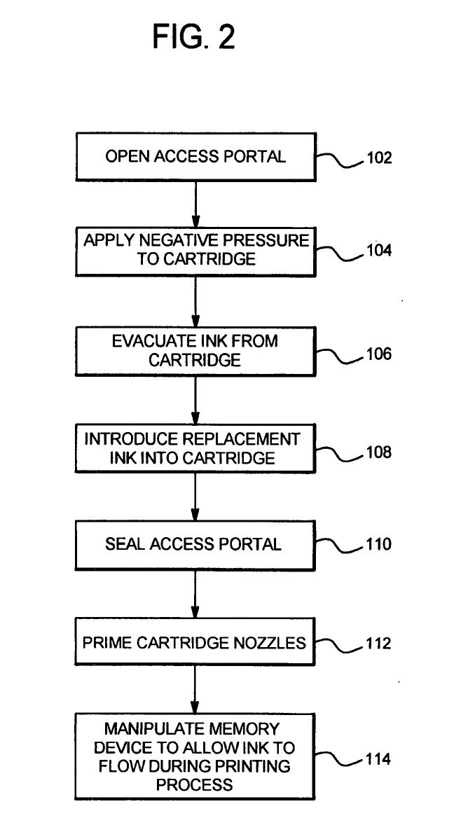

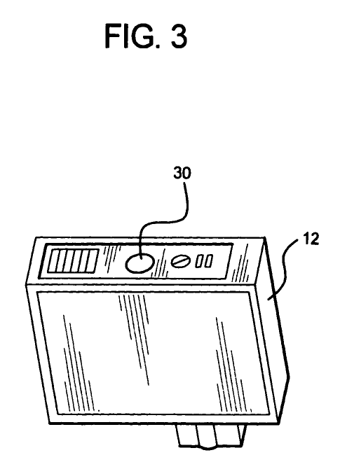

In an embodiment of the present invention, a process 100 is described herein, with reference to FIG. 2. The process 100 comprises a first step 102 of opening an access portal into the interior compartment 20 of the cartridge 12. FIG. 3 illustrates a cartridge 12 having an access portal drilled into the cartridge 12, thereby causing a hole 30 to form in the cartridge 12 providing access to the interior compartment 20. The hole 30 may be formed by the use of a hand drill, a drill press, rotary tool, punch, or other tool or device useful for opening the access portal in the cartridge 12.

Alternatively, original fill holes may be opened for obtaining access to the interior compartment 20 of the cartridge 12. Specifically, a hole may be drilled into the original fill holes, or the original fill holes may be unsealed to provide access to the interior compartment 20. It should be noted that the original fill holes of ink jet ink cartridges are generally sealed in such a that that prevents them from being unsealed without damaging the cartridge. Reuse of the original fill holes typically leads to delamination of the seal and severe leakage. However, the present invention should not be limited in that the original fill holes may be utilized to form the access portal into the internal compartment 20 of the cartridge 12, if feasible.

In a second step 104 of the process in the embodiment of the present invention, negative pressure is applied to the cartridge. The negative pressure is applied by vacuum under a pressure sufficiently low as to eliminate air within empty spaces within the cartridge 12. The pressure can be reduced by either pulling a vacuum on the interior of the cartridge 12 with an inserted and sealed nozzle assembly (not shown), or by having the entire cartridge 12 contained within a vacuum chamber. It should be noted that a full vacuum is not typically required, and is typically unattainable, but a partial vacuum may be pulled on the cartridge 12.

In a third step 106 of the process in the embodiment of the present invention, any remaining ink contained within the internal compartment 20 of the cartridge 12 is allowed to evacuate from the cartridge, while the cartridge is under some amount of negative pressure. In some circumstances, there will not be any ink remaining in the cartridge 12. In other circumstances, a small amount may be left, especially after the original ink contained therein has been mostly utilized in printing processes. However, it should be noted that any amount of ink may be contained within the cartridge, and may be removed or evacuated pursuant to step 106. In a preferred embodiment, the ink is removed from the cartridge 12 using a sealed nozzle assembly (not shown) and applying a vacuum to the interior of the cartridge 12. Moreover, the sealed nozzle assembly may be applied to the ink outlet port of the cartridge, and engaging one or more ventilation valves on the cartridge 12.

In a further step 108 of the process in the embodiment of the present invention, replacement ink is introduced into the internal compartment 20 of the cartridge 12 through the access portal that had been opened into the cartridge. The replacement ink is added until it reaches a usable level within the cartridge, such as completely filled, or otherwise to a specified amount.

After ink has been introduced into the internal compartment 20 of the cartridge 12, the access portal is sealed, preferably also under negative pressure, thereby maintaining negative pressure within the cartridge after the access portal is sealed via step 110. In a preferred embodiment, the access portal is sealed with a low durometer septum or plug, but can also be sealed with another piece of plastic that is either glued, heat staked, or ultrasonically welded to the access portal.

After the access portal 12 has been sealed via step 110, the cartridge is primed via step 112 to maximize the flowability of ink through the nozzles of the cartridge 12. The priming step 112 typically is utilized to balance or otherwise equilibrate the nozzles for providing free flowability of ink through the nozzles. The priming assembly may preferably be comprised of a rigid tube that can be inserted into the ink supply port of the cartridge 12. Once the tube is inserted, it may engage a “check valve” of the cartridge 12, and allows a vacuum to be applied to the interior of the cartridge 12. The vacuum then initiates the flow of ink and eliminates air bubbles that may interfere with proper printing during use of the cartridge 12 in a printing process.

In a final step 114, the memory device 18 is manipulated to allow ink to flow from the cartridge 12 in a printing process. The memory device 18 may be a microchip, or other memory device that can store data. The memory device 18 may be fed electrical signals that reset the memory device or otherwise change the information contained on the memory device, such as the date of manufacture, the name of the manufacturer of the cartridge, and/or the amount of ink recorded to have flowed from the cartridge. For example, if the memory device is designed to prevent ink from flowing therefrom based on the date, the date contained within the memory of the memory device may be changed to allow ink to flow therefrom.

More typically, the memory device has measured the amount of ink having flowed from the cartridge while in use. The electrical signals may reset or change the data, thereby resetting the data to an amount below the threshold value, such as to zero. By manipulating the memory device in this way, the memory device should allow the control system 16 to allow ink to flow from the cartridge 12.

In a preferred embodiment, the memory device 18 may be a microchip that is connected to a computing device via a flex circuit, pogo pin or other like circuit enabling device. The microchip is reset by first supplying power and ground to the microchip. Next, a command is sent to the microchip, at the proper clock speed, so enable accessing of the memory of the microchip. The microchip may then receive one or a series of write commands to reset the microchip, such as to reset the ink level field to full (i.e. to 100), to reset the date of manufacture, or to change or erase any other data that may interfere with the proper functioning of the microchip. Specifically, data may be written to other memory locations, such as, for example, to overwrite information, such as the date code, the name of the manufacturer, the time of manufacture, or any other information contained on the chip.

It may be useful to erase data contained on the memory device to enable proper functioning of the memory device 18 when utilizing the cartridge 12 in a printing process. Moreover, it may be useful to reprogram the memory device 18 after erasing said memory device 18 to enable proper functioning.

In an alternate embodiment of the present invention, the chip may be removed from the cartridge 12, after refilling said cartridge 12 with ink. A replacement memory device 18 may be added to the cartridge 12 with data contained thereon, or with data fields accessible and programmable, such that the memory device 18 may enable proper functioning when the cartridge 12 is utilized in a printing process.

While the foregoing has described what is considered to be the best mode and/or other examples, it is understood that various modifications may be made therein and that the subject matter disclosed herein may be implemented in various forms and examples, and that they may be applied in numerous other applications, combinations and environments, only some of which have been described herein. Those of ordinary skill in that art will recognize that the disclosed aspects may be altered or amended without departing from the true spirit and scope of the subject matter. Therefore, the subject matter is not limited to the specific details, exhibits and illustrated examples in this description. It is intended to protect any and all modifications and variations that fall within the true scope of the advantageous concepts disclosed herein.

We claim:

1. A process for filling an ink jet ink cartridge with ink comprising the steps of:
providing an ink jet ink cartridge comprising a memory device designed to prevent the reuse of the cartridge;
opening an access portal in the cartridge to access an interior chamber of the cartridge;
providing a negative pressure to the interior chamber of the cartridge;
introducing ink into the cartridge; and
manipulating the memory device to allow ink to flow from the cartridge in a printing process.

2. The process of claim 1 wherein the memory device records the volume of ink flowing from the cartridge.

3. The process of claim 1 wherein the cartridge contains an amount of remaining ink and further comprising the step of allowing the amount of remaining ink to be removed from the interior chamber of the cartridge prior to introducing the ink into the cartridge.

4. The process of claim 1 further comprising the step of priming said cartridge to allow the free flow of the ink therefrom in a printing process.

5. The process of claim 4 wherein the step of priming said cartridge comprises balancing a nozzle contained on the cartridge to allow the proper flow of the ink from the cartridge during a printing process.

6. The process of claim 1 wherein the memory device prevents the reuse of the cartridge by preventing the cartridge from allowing ink to flow therefrom if a threshold volume of ink is recorded to have flowed therefrom during printing processes.

7. The process of claim 1 wherein the step of opening the access portal in the cartridge comprises drilling a hole in the cartridge to access the interior compartment of the cartridge.

8. The process of claim 1 wherein the step of opening the access portal in the cartridge comprises opening fill holes utilized to add ink to the cartridge during an original manufacture of the ink cartridge.

9. The process of claim 1 wherein the step of manipulating said memory device comprises applying electrical signals to the memory device.

10. The process of claim 1 wherein the step of manipulating said memory device comprises electrically changing data contained within the memory device, wherein said data is selected from the group consisting of ink volume data, a date of manufacture of the ink jet ink cartridge, and a name of a manufacturer of the ink jet ink cartridge.

11. An ink jet ink cartridge made by a process comprising the steps of:
providing an ink jet ink cartridge comprising a memory device designed to prevent the reuse of the cartridge;
opening an access portal in the cartridge to access an interior chamber of the cartridge;
providing a negative pressure to the interior chamber of the cartridge;
introducing ink into the cartridge; and
manipulating the memory device to allow ink to flow from the cartridge in a printing process.

12. The ink jet ink cartridge of claim 11 wherein the memory device records the volume of ink flowing from the cartridge.

13. The ink jet ink cartridge of claim 11 wherein the cartridge contains an amount of remaining ink and further comprising the step of allowing the amount of remaining ink to be removed from the interior chamber of the cartridge prior to introducing the ink into the cartridge.

14. The ink jet ink cartridge of claim 11 further comprising the step of priming said cartridge to allow the free flow of the ink therefrom in a printing process.

15. The ink jet ink cartridge of claim 14 wherein the step of priming said cartridge comprises balancing a nozzle contained on the cartridge to allow the proper flow of the ink from the cartridge during a printing process.

16. The ink jet ink cartridge of claim 11 wherein the memory device prevents the reuse of the cartridge by preventing the cartridge from allowing ink to flow therefrom if a threshold volume of ink is recorded to have flowed therefrom during printing processes.

17. The ink jet ink cartridge of claim 11 wherein the step of opening the access portal in the cartridge comprises drilling a hole in the cartridge to access the interior compartment of the cartridge.

18. The ink jet ink cartridge of claim 11 wherein the step of opening the access portal in the cartridge comprises opening fill holes utilized to add ink to the cartridge during an original manufacture of the ink cartridge.

19. The ink jet ink cartridge of claim 11 wherein the step of manipulating said memory device comprises applying electrical signals to the memory device.

20. The ink jet ink cartridge of claim 11 wherein the step of manipulating said memory device comprises electrically changing data contained within the memory device, wherein said data is selected from the group consisting of the ink volume data, a date of manufacture of the ink jet ink cartridge, and a name of a manufacturer of the ink jet ink cartridge.

21. A process for filling an ink jet ink cartridge with ink comprising the steps of:
providing an ink jet ink cartridge comprising a first memory device designed to prevent the reuse of the cartridge;
opening an access portal in the cartridge to access an interior chamber of the cartridge;
providing a negative pressure to the interior chamber of the cartridge;
introducing ink into the cartridge; and
replacing the first memory device with a second memory device.

22. The process of claim 21 wherein the first memory device records the volume of ink flowing from the cartridge.

23. The process of claim 21 wherein the cartridge contains an amount of remaining ink and further comprising the step of allowing the amount of remaining ink to be removed from the interior chamber of the cartridge prior to introducing the ink into the cartridge.

24. The process of claim 21 further comprising the step of priming said cartridge to allow the free flow of the ink therefrom in a printing process.

25. An ink cartridge made by the process of claim 21.
